(19) United States
(12) Patent Application Publication
(10) Pub. No.: US 2019/0023568 A1
(43) Pub. Date: Jan. 24, 2019

(54) CATALYST AND METHOD FOR PRODUCING CHLORINE BY MEANS OF GAS PHASE OXIDATION

(71) Applicant: Covestro Deutschland AG, Leverkusen (DE)

(72) Inventors: Andre RITTERMEIER, Bochum (DE); Michael VENZ, Dormagen (DE)

(21) Appl. No.: 16/071,576

(22) PCT Filed: Feb. 3, 2017
(86) PCT No.: PCT/EP2017/052392

§ 371 Date: Jul. 20, 2018

(30) Foreign Application Priority Data
Feb. 4, 2016 (EP) 16154252.7

(51) Int. Cl. C01B 7/04; B01J 23/63; B01J 35/00; B01J 35/02; B01J 35/10; B01J 37/02

(52) U.S. Cl. CPC C01B 7/04; B01J 23/63; B01J 35/0026; B01J 35/023; B01J 2523/3712; B01J 35/1061; B01J 37/0201; B01J 2523/821; B01J 35/1066

(57) ABSTRACT

The invention relates to known catalysts which contain cerium or other catalytically active components for producing chlorine by means of a catalytic gas phase oxidation of hydrogen chloride with oxygen. A catalyst material is described for producing chlorine by means of a catalytic gas phase oxidation of hydrogen chloride with oxygen, wherein the catalyst comprises at least oxide compounds of the cerium as active components and zirconium dioxide microparticles as the carrier components, and the catalyst is characterized by a particularly high yield, measured in kg_{Cl2}/kg_{KA} T·h, based on the mass of the catalyst.

The invention proceeds from known catalysts containing cerium or other catalytically active components for producing chlorine by catalytic gas phase oxidation of hydrogen chloride with oxygen. The invention relates to a supported catalyst for producing chlorine by catalytic gas phase oxidation of hydrogen chloride with oxygen, wherein the catalyst comprises at least oxide compounds of cerium as the active component and zirconium dioxide as the support component and wherein the catalyst features a particularly high yield based on the catalyst mass measured in kg_{Cl2}/kg_{CAT}·h and wherein the support features a particular particle form.

The process of catalytic hydrogen chloride oxidation with oxygen in an exothermic equilibrium reaction developed by Deacon in 1868 was at the genesis of industrial chlorine chemistry:

4HCl+O₂⇒2Cl₂+2H₂O.

Chloralkali electrolysis, however, eclipsed the Deacon process to a substantial degree. Virtually all chlorine was produced by electrolysis of aqueous sodium chloride solutions [Ullmann Encyclopedia of industrial chemistry, seventh release, 2006]. However, the attractiveness of the Deacon process has been increasing recently, since global chlorine demand is growing faster than the demand for sodium hydroxide solution. This development favors the process for producing chlorine by oxidation of hydrogen chloride decoupled from the production of sodium hydroxide solution. In addition, hydrogen chloride is obtained as a coproduct in large amounts in phosgenation reactions for example, for instance in isocyanate production.

The first catalysts for HCl gas phase oxidation contained copper in the oxidic form as an active component and had been described by Deacon as early as 1868. These catalysts deactivated rapidly because the active component was volatilized at the high process temperatures.

HCl gas phase oxidation by means of chromium oxide-based catalysts is also known. However, under oxidizing conditions chromium-based catalysts have a tendency to form chromium(VI) oxides which are very toxic and have to be prevented from entering the environment, thus entailing technical complexity. Furthermore, a short service life is implied in other publications (WO 2009/035234 A, page 4, line 10).

Ruthenium-based catalysts for HCl gas phase oxidation were described for the first time in 1965, but the activity of these RuCl₃/SiO₂ catalysts was quite low (see: DE 1567788 A1). Further catalysts comprising the active components ruthenium dioxide, mixed oxides of ruthenium or ruthenium chloride in combination with various support oxides, such as titanium dioxide or tin dioxide have also been described previously (see for example: EP 743277A1, U.S. Pat. No. 5,908,607, EP 2026905 A1 and EP 2027062 A2). In the case of ruthenium-based catalysts optimization of the support is thus already well advanced.

Ruthenium-based catalysts have a rather high activity and stability at a temperature in the range of 350-400° C. However, the stability of ruthenium-based catalysts above 400° C. has still not been unequivocally demonstrated (WO 2009/035234 A2, page 5, line 17). Furthermore, the platinum group metal ruthenium is very scarce and very costly, and the price of ruthenium on the global market is highly variable. There is therefore a need for alternative catalysts having higher availability and comparable effectiveness.

WO 2009/035234 A2 describes cerium oxide catalysts for HCl gas phase oxidation (see claims 1 and 2); a support is at least considered therein. However, possible suitable supports are not disclosed in any detail.

DE 10 2009 021 675 A1describes a process for producing chlorine by catalytic oxidation of hydrogen chloride in the presence of a catalyst which comprises an active component and optionally a support material and wherein the active component comprises at least one cerium oxide compound. Example 5 of DE 10 2009 021 675 A1 describes a catalyst material comprising cerium oxide on lanthanum-zirconium oxide as a catalyst support and gives a detailed description of the efficacy of this catalyst material in use example 11 of DE 10 2009 021 675 A1. It is apparent from DE 10 2009 021 675 A1 that the activity of this catalyst material is lowest compared to all the other catalysts tested therein. Suitable support materials for the cerium oxide catalyst mentioned “by way of example” are the substances: silicon dioxide, aluminum oxide (e.g. in the α or γ modifications), titanium dioxide (as rutile, anatase etc.), tin dioxide, zirconium dioxide, uranium oxide, carbon nanotubes or mixtures thereof, there being no further examples or any consideration of the advantages and disadvantages of the listed supports with respect to one another (see paragraph [0017] of DE 10 2009 021 675 A1). The aforementioned list is an arbitrary enumeration of support materials known per se for ruthenium catalysts in the HCl gas phase oxidation, which has been extended by addition of a known active component (uranium).

The person skilled in the art of catalyst development infers from the disclosure of DE 10 2009 021 675 A1 that the use of cerium oxide in supported catalysts does not give a useful catalyst material.

WO 2013/060628 A1 is considered as the closest prior art to the invention and describes an improved catalyst material which instead of scarce ruthenium is based on cerium as the catalytically active component and in supported form exhibits a significantly higher effectiveness.

The present invention accordingly has for its object, starting from the abovementioned prior art, to find an improved catalyst material exhibiting a significantly higher effectiveness. A particular object is that of identifying for the active component cerium oxide an optimal catalyst support for use in HCl gas phase oxidation.

The object is achieved by supporting oxide compounds of cerium on porous microparticles of zirconium dioxide.

Specifically, it has surprisingly been found
that at a comparable loading of 7% by weight the best novel CeO₂/ZrO₂ microparticle catalyst (2.25 kg_{Cl2}/kg_{CAT}·h, ex. 1) exhibits a yield based on the catalyst mass that is 1.9 times higher than the best noninventive alternative catalyst (CeO₂/ZrO₂: 1.17 kg_{Cl2}/kg_{CAT}·h, ex. 13), the active component cerium is thus markedly better utilized in the case of these novel CeO₂/ZrO₂ microparticle catalysts than in the case of other commonly used supports, and
that the best novel CeO₂/ZrO₂ microparticle catalyst (2.72 kg_{Cl2}/kg_{CAT}·h, ex. 4) exhibits a yield based on the catalyst mass that is 2.1 times higher than the best noninventive alternative catalyst (CeO₂/ZrO₂: 1.28 kg_{Cl2}/kg_{CAT}·h, ex. 14) even at a lower loading of active component CeO₂.

The invention provides a catalyst material composed of a porous catalyst support and a catalytic coating for a process for thermocatalytic production of chlorine from hydrogen chloride and oxygen-containing gas, wherein the catalyst material at least comprises: at least one oxide compound of cerium as the catalytic coating and spherical zirconium dioxide microparticles as the support component.

The average particle size of the zirconium dioxide microparticles, in particular of different support batches, may preferably be from 100 to 1000 μm. In a preferred embodiment of the invention the D₉₀ and D₁₀ values of the particle size distribution deviate from the D₅₀ value by not more than 10%.

In a preferred embodiment the novel catalyst material is characterized in that the catalyst material, in particular after calcination, has a bulk density of at least 700 kg/m³, particularly preferably of at least 1000 kg/m³, very particularly preferably of at least 1200 kg/m', in particular measured in a DN100 graduated cylinder having a fill height of 250 mm.

In a preferred embodiment the catalyst support consists to an extent of at least 90% by weight, preferably to an extent of at least 97% by weight, of zirconium dioxide, in particular measured by the X-ray fluorescence analysis method for the metal content and X-ray diffraction for detection of the oxide structure.

In a preferred embodiment the catalyst support consists of spherical particles.

Preference is given to a novel catalyst material characterized in that the catalyst support consists of spherical particles. In a preferred embodiment of the catalyst material the average particle size (diameter) of the catalyst support is 0.1 mm to not more than 1.0 mm, preferably 0.3 mm to 0.85 mm, wherein the D₉₀ and D₁₀ values of the particle size distribution deviate from the D₅₀ value by not more than 10%, in particular measured by laser diffraction.

A further preferred embodiment of the novel catalyst material is characterized in that during its production the catalyst material is subjected to a high temperature calcination in the presence of oxygen-containing gases, in particular of air, wherein the calcination temperature is in the range 300° C. to 1100° C., preferably 400° C. to 800° C., particularly preferably 500° C. to 600° C. The high-temperature calcination is particularly preferably over a period of 30 min to 24 h. The high-temperature calcination particularly increases the long-term stability of the catalyst.

In a preferred embodiment the novel catalyst material is characterized in that the porous catalyst support in the uncoated state (i.e. prior to application of the catalytic active component) has a pore diameter distribution having a maximum in the range of small pores in the low nanometer range, wherein preferably the median diameter of a pore class 1 of relatively large pores is from 30 to 200 nm and the median diameter of a pore class 2 of relatively small pores is from 2 to 25 nm and wherein particularly preferably the median of a pore class 1 is from 100 to 140 nm and the median of a pore class 2 is from 4 to 11 nm, wherein the pore diameters are in particular measured by mercury porosimetry. The pores of pore class 1 preferably also serve as transport pores during catalyst preparation, in order that the pores of pore class 2 can also be filled with the solvent containing cerium compounds during the preparation by dry impregnation (incipient wetness). The pores of pore class 1 preferably also serve as transport pores during HCl gas phase oxidation, in order that the pores of pore class 2 are also adequately supplied with feed gases and product gases are removed.

In a preferred embodiment the novel catalyst material is characterized in that the catalyst support in the uncoated state (i.e. prior to application of the catalytic active component) has a surface area of 30 to 250 m²/g, preferably of 80 to 120 m²/g, in particular measured by the nitrogen adsorption method with evaluation according to BET.

It is very particularly preferable to employ for example a novel ZrO₂ microparticle catalyst support having the following specifications:
Specific surface area in the range of 102 m²/g (nitrogen adsorption, evaluation according to BET)
Bimodal pore radius distribution, wherein a pore class 1 (transport pores) has a median in the range of 110 nm and a pore class 2 (fine pores) has a median in the range of 8 nm (mercury porosimetry)
Pore volume in the range of 0.65 cm³/g (mercury porosimetry)
Bulk density in the range of 722 kg/m³

In a preferred embodiment the novel catalyst material is characterized in that the support component zirconium dioxide is present in the monoclinic crystal form to an extent of at least 90% by weight, preferably to an extent of at least 99% by weight, in particular estimated by X-ray diffraction.

In a preferred execution, the novel catalyst material is characterized in that the content of cerium based on the total weight of the catalyst material is 1% to 30% by weight, preferably 5% to 20% by weight and particularly preferably 12% to 17% by weight.

In a preferred embodiment the novel catalyst material is characterized in that the oxide compounds of cerium are the exclusive catalytic active components on the catalyst support.

Preferred oxide compounds of cerium for use in the novel catalyst material are Ce(III) oxide (CeO₃) and cerium(IV) oxide (CeO₂). Under conditions for HCl gas phase oxidation, Ce—Cl structures (Ce chlorides) and also O—Ce—Cl structures (Ce oxychlorides) are also to be expected at least at the surface.

In a preferred embodiment the novel catalyst material is characterized in that the catalyst material is obtained when a cerium compound, in particular a compound from the group of: cerium nitrate, acetate or chloride in solution is applied to the support by means of dry impregnation and the impregnated support is subsequently dried and calcinated at relatively high temperature.

The coatings comprising catalytically active oxide compounds of cerium are preferably obtainable by a process comprising initial application of a solution or suspension, especially an aqueous solution or suspension, of a cerium compound, preferably cerium nitrate, acetate or chloride, to the catalyst support, so that the solution is particularly preferably supernatantlessly absorbed by the catalyst support (also called “dry impregnation”), and subsequent removal of the solvent. Preferably, the catalytic active component, i.e. the oxide compound of cerium, may alternatively also be applied to the support by precipitation and coprecipitation processes, and also ion exchange and gas phase coating (CVD, PVD).

The application of the cerium compound is generally followed by a drying step. The drying step is preferably effected at a temperature of 50° C. to 150° C., particularly preferably at 70° C. to 120° C. The drying time is preferably 10 min to 10 h. The catalyst material may be dried at standard pressure or preferably at reduced pressure, particularly preferably 50 to 500 mbar (5 to 50 kPa), very particularly preferably at about 100 mbar (10 kPa). Drying under reduced pressure is advantageous in order to be able to better fill pores having a small diameter <40 nm in the support with the preferably aqueous solution of the catalyst precursor in the first drying step.

The drying is in particular followed by a calcination step. Calcination is preferably performed at a temperature of 300° C. to 1100° C., particularly preferably at 400° C. to 800° C., very particularly preferably at 500° C. to 600° C. Calcination is in particular effected in the presence of oxygen-containing gases, particularly preferably in air. The calcination time is preferably 30 min to 24 h.

The uncalcinated precursor of the novel catalyst material may also he calcinated in the reactor for the HCl gas phase oxidation itself, or particularly preferably under reaction conditions.

The invention further provides a process for thermocatalytic production of chlorine from hydrogen chloride and oxygen-containing gas, characterized in that a catalyst material according to the invention is used as catalyst.

It is preferable when in the novel oxidation process the temperature is altered from one reaction zone to the next reaction zone. It is preferable when the catalyst activity is altered from one reaction zone to the next reaction zone. It is particularly preferable when the two measures are combined. Suitable reactor concepts are described for example in EP 1 170 250 B1 and JP 2004099388 A. Activity and/or temperature profiling can help to control the position and severity of any hotspots.

The average reaction temperature when using the novel catalyst material for the purposes of HCl gas phase oxidation is preferably 300° C.-600° C., particularly preferably 350° C.-550° C. At markedly below 300° C. the activity of the novel catalyst is very low; at markedly above 600° C. nickel alloys typically employed as construction materials and also unalloyed nickel do not exhibit long-term stability toward the corrosive reaction conditions.

It is preferable when the outflow temperature of the reaction gases from the reactor when using the novel catalyst material for the purposes of HCl gas phase oxidation is not more than 450° C., particularly preferably not more than 420° C. A reduced outflow temperature may be advantageous because the equilibrium of the exothermic HCl gas phase oxidation is then more favorable.

The O₂/HCl ratio of the inflowing the reaction mixture is preferably equal to or greater than 0.75 in every part of the bed containing the novel catalyst. From an O₂/HCl ratio equal to or greater than 0.75, the activity of the novel catalyst material is maintained for longer than when the O₂/HCl ratio is lower.

The temperature in a reaction zone is preferably raised as the catalyst undergoes deactivation. It is particularly preferable when the initial activity of the novel catalyst is partly to fully restored by a treatment with a higher O₂//HCl ratio than under regular conditions for the HCl gas phase oxidation, preferably at least twice as high, or under virtually HCl-free conditions (HCl/O₂ ratio=0), for example in air. It is particularly preferable when this treatment is performed for up to 5 h at otherwise typical temperatures for the HCl gas phase oxidation.

It is preferable when the novel catalyst material is combined with a ruthenium catalyst on a separate support, wherein the ruthenium catalyst is employed as a low-temperature complement, particularly preferably in the temperature range of 200-400° C., and the novel catalyst is employed as a high-temperature complement, particularly preferably in the temperature range of 300-600° C. In this case, the two catalyst types are arranged in different reaction zones.

It is preferable when, as described previously hereinabove, the novel catalyst material is used in the catalytic process known as the Deacon process. In this process, hydrogen chloride is oxidized with oxygen in an exothermic equilibrium reaction to afford chlorine while generating steam. The typical reaction pressure is 1 to 25 bar, preferably 1.2 to 20 bar, particularly preferably 1.5 to 17 bar, very particularly preferably 2 to 15 bar. Since this is an equilibrium reaction, it is advantageous to use oxygen in superstoichiometric amounts relative to hydrogen chloride. A two-to four-fold oxygen excess, for example, is typical. Since there is no risk of any selectivity losses operation at relatively high pressure, and accordingly with a longer residence than at standard pressure, may be economically advantageous.

The invention also provides for the use of the novel catalyst material as a catalyst in the thermocatalytic production of chlorine from hydrogen chloride and an oxygen-containing gas.

The catalytic hydrogen chloride oxidation may be performed adiabatically or isothermally or virtually isothermally, batchwise hut preferably continuously, as a fluidized bed process or fixed bed process, preferably as a fixed bed process, particularly preferably adiabatically at a pressure of 1 to 25 bar (1000 to 25000 hPa), preferably 1.2 to 20 bar, particularly preferably 1.5 to 17 bar and especially preferably 2.0 to 15 bar.

A preferred process is characterized in that the gas phase oxidation is operated isothermally in at least one reactor.

An alternative preferred process is characterized in that the gas phase oxidation is conducted in an adiabatic reaction cascade consisting of at least two serially connected adiabatically operated reaction stages with intermediate cooling.

Typical reaction apparatuses in which the catalytic hydrogen chloride oxidation is performed are fixed bed or fluidized bed reactors. The catalytic hydrogen chloride oxidation may preferably also be performed as a multi-stage procedure.

In the adiabatic, isothermal or virtually isothermal process regime, but preferably in the adiabatic process regime, it is also possible to use two or more, in particular 2 to 10, preferably 2 to 6, serially connected reactors with intermediate cooling. The addition of the hydrogen chloride may be effected such that it is added in its entirety upstream of the first reactor together with the oxygen or such that it is distributed over the various reactors. This serial connection of individual reactors can also be combined in one apparatus.

In a preferred embodiment the novel catalyst is used for the purposes of HCl gas phase oxidation in an adiabatic reaction cascade consisting of at least two serially connected stages with intermediate cooling. The adiabatic reaction cascade preferably comprises 3 to 7 stages including respective intermediate cooling of the reaction gases. It is particularly preferable when the addition of the HCl is effected such that it is not added in its entirety upstream of the first stage but rather is added distributed over the individual stages, in each case upstream of the respective catalyst bed, or especially preferably upstream of the respective intermediate cooling.

In a preferred embodiment the novel catalyst is used for the purposes of HCl gas phase oxidation in an isothermal reactor, particularly preferably in just one isothermal reactor, in particular in just one shell and tube reactor in the direction of flow of the feed gases. The shell and tube reactor is preferably divided into 2 to 10 reaction zones, more preferably into 2 to 5 reaction zones, in the direction of flow of the feed gases. In a preferred embodiment the temperature of a reaction zone is controlled by surrounding cooling chambers within which a cooling medium flows and removes the heat of reaction. A suitable shell and tube reactor is discussed in “Trends and Views in the Development of Technologies for Chlorine Production from Hydrogen Chloride”, SUMITOMO KAGAKU 2010-II, by Hiroyuki ANDO, Youhei UCHIDA, Kohei SEKI, Carlos KNAPP, Norihito OMOTO and Masahiro KINOSHITA.

A further preferred embodiment of an apparatus suitable for the process consists in using a structured catalyst bed in which the catalyst activity increases in the direction of flow. Such a structuring of the catalyst bed can be accomplished through varying impregnation of the catalyst supports with active material or through varying dilution of the catalyst with an inert material. Employable inert materials are for example rings, cylinders or spheres of titanium dioxide, zirconium dioxide or mixtures thereof, aluminum oxide, steatite, ceramic, glass, graphite or stainless steel. The inert material should preferably have similar external dimensions to the catalyst particles.

In a preferred variant of the novel process, the cerium-containing catalyst material is combined with a ruthenium catalyst or a catalyst containing ruthenium compounds on a separate support, wherein the ruthenium catalyst is employed as a low-temperature complement, preferably in the temperature range from 200° C. to 400° C., and the cerium-containing catalyst material is employed as a high-temperature complement, preferably in the temperature range from 300° C. to 600° C.

It is particularly preferable when the two different catalyst types are arranged in different reaction zones.

The conversion of hydrogen chloride in the HCl oxidation in single pass may preferably be limited to 15% to 90%, preferably 40% to 90%, particularly preferably 70% to 90%, Unconverted hydrogen chloride may, after separation, be fully or partly recycled into the catalytic hydrogen chloride oxidation.

The heat of reaction of the catalytic hydrogen chloride oxidation may advantageously be utilized to raise high-pressure steam. This steam may be utilized to operate a phosgenation reactor and/or distillation columns, in particular isocyanate distillation columns.

In a further step, the chlorine formed is separated. The separation step typically comprises a plurality of stages, specifically separation and optional recycling of unconverted hydrogen chloride from the product gas stream of the catalytic hydrogen chloride oxidation, drying of the obtained stream essentially comprising chlorine and oxygen and removal of chlorine from the dried stream.

Separation of unconverted hydrogen chloride and of steam formed may be effected by condensing aqueous hydrochloric acid out of the product gas stream from the hydrogen chloride oxidation by cooling. Hydrogen chloride can also be absorbed in dilute hydrochloric acid or water.

The examples which follow elucidate, the present invention:

### EXAMPLES

The essential parameters and results from the examples which follow are summarized in a table after the final example.

### Example 1 (Inventive)

A ZrO₂ microparticle catalyst support (manufacturer: Saint-Gobain NorPro, 0.781 mm diameter microparticles) of monoclinic structure and having the following specifications was employed:
Specific surface area of 102 m²/g (nitrogen adsorption, evaluation according to BET)
Bimodal pore radius distribution where a pore class 1 (transport pores) has a median of 110 nm and a pore class 2 (fine pores) has a median of 8 nm (mercury porosimetry)
Pore volume of 0.65 cm³/g (mercury porosimetry)
Bulk density of 722 kg/m³ (measured in a DN100 graduated cylinder of 250 mm in height)

20.6 g of cerium(III) nitrate hexahydrate were made up to 25 ml with deionized water. 0.288 ml of the thus produced cerium(III) nitrate solution was initially charged into a snap-lid bottle having been diluted with an amount of deionized water sufficient to fill the total pore volume and 1 g of the ZrO₂ catalyst support was stirred in until the initially charged solution was fully absorbed (dry impregnation methodology). The impregnated ZrO₂ catalyst support was then dried at 120° C. for 5 h and then calcinated in a muffle furnace in air. To this end, the temperature in the muffle furnace was increased linearly from 20° C. to 500° C. over 160 min and held at 500° C. for 5 h. The muffle furnace was then cooled linearly from 500° C. to 20° C. over 160 min. The supported amount of cerium corresponds to a proportion of 7% by weight based on the calcinated catalyst, wherein the catalyst components are calculated as CeO₂ and ZrO₂.

0.25 g of the thus prepared catalyst was diluted with 0.5 g of Spheriglass (quartz glass, 500-800 μm) and initially charged in a fixed bed in a quartz reaction tube (internal diameter 8 mm) before a gas mixture of 1 L/h (standard conditions, STP) of hydrogen chloride, 4 L/h (STP) of oxygen and 5 L/h of nitrogen (STP) were passed therethrough at 430° C. The quartz reaction tube was heated by an electrically heated oven. After 2 h, the product gas stream was passed into a 30% by weight potassium iodide solution for 30 min. The iodine formed was then back-titrated with 0.1 N thiosulfate standard solution to determine the amount of chlorine introduced. A chlorine formation rate of 2.25 kg_{Cl2}/kg_{CAT}·h (based on the catalyst mass) was measured.

### Example 2 (Inventive)

1 g of a catalyst according to example 1 was produced, wherein the supported amount of cerium was adjusted to a proportion of 9% by weight based on the calcinated catalyst. The catalyst was tested in accordance with example 1. A chlorine formation rate of 2.35 kg_{Cl2}/kg_{CAT}·h was measured.

### Example 3 (Inventive)

1 g of a catalyst according to example 1 was produced, wherein the supported amount of cerium was adjusted to a proportion of 14% by weight based on the calcinated catalyst. The catalyst was tested in accordance with example 1. A chlorine formation rate of 2.64 kg_{Cl2}/kg_{CAT}·h was measured.

### Example 4 (Inventive)

1 g of a catalyst according to example 1 was produced, wherein the supported amount of cerium was adjusted to a proportion of 17% by weight based on the calcinated catalyst. The catalyst was tested in accordance with example 1. A chlorine formation rate of 2.72 kg_{Cl2}/kg_{CAT}·h was measured.

### Example 5 (Inventive)

1 g of a catalyst according to example 1 was produced, wherein the supported amount of cerium was adjusted to a proportion of 20% by weight based on the calcinated catalyst. The catalyst was tested in accordance with example 1. A chlorine formation rate of 2.62 kg_{Cl2}/kg_{CAT}·h was measured.

### Example 6 (Inventive)

1 g of a catalyst according to example 1 was produced, wherein the supported amount of cerium was adjusted to a proportion of 30% by weight based on the calcinated catalyst. The catalyst was tested in accordance with example 1. A chlorine formation rate of 2.36 kg_{Cl2}/kg_{CAT}·h was measured.

Given sufficient Ce loadings (ex. 3-5) the catalysts based on undoped ZrO₂ as support material exhibit the best yields (2.6-2.7 kg_{Cl2}/kg_{CAT}·h). Up to a loading of 14% by weight the yield based on catalyst mass of these particularly preferred CeO₂/ZrO₂ catalysts (active component/support) increases with cerium content. At a loading of 14-20% by weight the yield based on catalyst mass remains approximately constant; the ZrO₂ catalyst support is saturated with active component. From a loading of 30% by weight the yield based on catalyst mass decreases; the high proportion of active component appears to fill the small pores, thus reducing the available surface area.

### Example 7 (Comparative Example)

ZrO₂ microparticle catalyst support according to example 1 was tested in the same way as the catalyst in example 1. A chlorine formation rate of 0.00 kg_{Cl2}/kg_{CAT}·h was measured. ZrO₂ supports without the CeO₂ active component are thus suitable only as a support and not as an active component.

### Example 8 (Inventive)

A ZrO₂ catalyst support (manufacturer: Saint-Gobain NorPro; type: 0.372 mm diameter microparticles) of monoclinic structure and having the following specifications was employed:
Specific surface area of 93 m²/g (nitrogen adsorption, evaluation according to BET)
Pore volume of 0.42 cm³/g (mercury porosimetry)
Bulk density of 1000 kg/m³ (measured in a DN100 graduated cylinder of 250 mm in height)

This ZrO₂ microparticle catalyst support was pretreated according to example 1 and then used to produce 1 g of a catalyst according to example 1, wherein the supported amount of cerium was adjusted to a proportion of 5% by weight based on the calcinated catalyst. The catalyst was tested in accordance with example 1. A chlorine formation rate of 1.55 kg_{Cl2}/kg_{CAT}·h was measured.

### Example 9 (Inventive)

1 g of a catalyst according to example 10 was produced, wherein the supported amount of cerium was adjusted to a proportion of 7% by weight based on the calcinated catalyst. The catalyst was tested in accordance with example 10. A chlorine formation rate of 1.97 kg_{Cl2}/kg_{CAT}·h was measured.

### Example 10 (Inventive)

1 g of a catalyst according to example 10 was produced, wherein the supported amount of cerium was adjusted to a proportion of 9% by weight based on the calcinated catalyst. The catalyst was tested in accordance with example 10. A chlorine formation rate of 2.18 kg_{Cl2}/kg_{CAT}·h was measured.

### Example 11 (Inventive)

1 g of a catalyst according to example 10 was produced, wherein the supported amount of cerium was adjusted to a proportion of 15% by weight based on the calcinated catalyst. The catalyst was tested in accordance with example 10. A chlorine formation rate of 2.14 kg_{Cl2}/kg_{CAT}·h was measured.

Given sufficient Ce loadings (ex. 9-11) the catalysts based on undoped ZrO₂ as support material exhibit the best yields (2.0-2.2 kg_{Cl2}/kg_{CAT}·h). Up to a loading of 7-9% by weight the yield based on catalyst mass of these particularly preferred CeO₂/ZrO₂ catalysts (active component/support) increases with cerium content. At a loading of 15% by weight the yield based on catalyst mass remains approximately constant; the ZrO₂ catalyst support is saturated with active component.

### Example 12 (Comparative Example)

ZrO₂ microparticle catalyst support according to example 8 was tested in the same way as the catalyst in example 8. A chlorine formation rate of 0.00 kg_{Cl2}/kg_{CAT}·h was measured. ZrO₂ supports without the CeO₂ active component are thus suitable only as a support and not as an active component.

### Example 13 (Comparative Example)

A ZrO₂ catalyst support (manufacturer: Saint-Gobain NorPro; type: SZ 31163; extrudates of 3-4 mm in diameter and 4-6 mm in length) of monoclinic structure and having the following specifications (before pestling) was employed:
Specific surface area of 55 m²/g (nitrogen adsorption, evaluation according to BET)
Bimodal pore radius distribution where a pore class 1 (transport pores) has a median of 60 nm and a pore class 2 (fine pores) has a median of 16 nm (mercury porosimetry)
Pore volume of 0.27 cm³/g (mercury porosimetry)
Bulk density of 1280 kg/m³ (measured in a DN100 graduated cylinder of 350 mm in height)

This ZrO₂ catalyst support (SZ 31163) was crushed with a mortar and classified into screen fractions. 1 g of the 100-250 μm screen fraction was dried at 160° C. and 10 kPa for 2 h. 50 g of cerium(III) nitrate hexahydrate were dissolved in 42 g of deionized water. 0.19 ml of the thus produced cerium(III) nitrate solution was initially charged in a snap-lid bottle having been diluted with an amount of deionized water sufficient to fill the total pore volume and 1 g of the dried screen fraction (100-250 μm) of the ZrO₂ catalyst support was stirred in until the initially charged solution was fully absorbed (dry impregnation methodology). The impregnated ZrO₂ catalyst support was then dried at 80° C. and 10 kPa for 5 h and then calcinated in a muffle furnace in air. To this end, the temperature in the muffle furnace was increased linearly from 30° C. to 900° C. over 5 h and held at 900° C. for 5 h. The muffle furnace was then cooled linearly from 900° C. to 30° C. over 5 h. The supported amount of cerium corresponds to a proportion of 7% by weight based on the calcinated catalyst, wherein the catalyst components are calculated as CeO₂ and ZrO₂.

0.25 g of the thus prepared catalyst was diluted with 1 g of Spheriglass (quartz glass, 500-800 μm) and initially charged in a fixed bed in a quartz reaction tube (internal diameter 8 mm) before a gas mixture of 1 L/h (standard conditions, STP) of hydrogen chloride, 4 L/h (STP) of oxygen and 5 L/h of nitrogen (STP) were passed therethrough at 430° C. The quartz reaction tube was heated by an electrically heated oven. After 2 h, the product gas stream was passed into a 30% by weight potassium iodide solution for 30 min. The iodine formed was then hack-titrated with 0.1 N thiosulfate standard solution to determine the amount of chlorine introduced. A chlorine formation rate of 1.17 kg_{Cl2}/kg_{CAT}·h (based on the catalyst mass) was measured.

### Example 14 (Comparative Example)

1 g of a catalyst according to example 13 was produced, wherein the supported amount of cerium was adjusted to a proportion of 15% by weight based on the calcinated catalyst. The catalyst was tested in accordance with example 13. A chlorine formation rate of 1.28 kg_{Cl2}/kg_{CAT}·h was measured.

The essential parameters and results from the recited examples are summarized in the table below.

| Ex. | Support | Ce | STY |
|---|---|---|---|
| # | kg/m³ | % by weight | g/gh |
| 1 | ZrO₂ | 7 | 2.25 |
| 2 | ZrO₂ | 9 | 2.35 |
| 3 | ZrO₂ | 14 | 2.64 |
| 4 | ZrO₂ | 17 | 2.72 |
| 5 | ZrO₂ | 20 | 2.62 |
| 6 | ZrO₂ | 30 | 2.36 |
| 7 (comp.) | ZrO₂ | 0 | 0.00 |
| 8 | ZrO₂ | 5 | 1.55 |
| 9 | ZrO₂ | 7 | 1.97 |
| 10 | ZrO₂ | 9 | 2.18 |
| 11 | ZrO₂ | 15 | 2.14 |
| 12 (comp.) | ZrO₂ | 0 | 0.00 |
| 13 (comp.) | ZrO₂ | 7 | 1.17 |
| 14 (comp.) | ZrO₂ | 15 | 1.28 |

### CONCLUSIONS

ZrO₂ supports without the CeO₂ active component have zero activity (examples 7 and 12) and are thus suitable only as a support and not as an active component.

Given sufficient Ce loadings (ex. 3-5/9-10) the catalysts based on undoped microparticle ZrO₂ as support material exhibit the best yields (2.1-2.7 kg_{Cl2}/kg_{CAT}·h). Up to a loading of 7-14% by weight the yield based on catalyst mass of these two particularly preferred CeO₂/ZrO₂ microparticle catalysts (active component/support) increases with cerium content. From a loading of 14-20% by weight the yield based on catalyst mass remains approximately constant; the ZrO₂ microparticle catalyst support is saturated with active component. From a loading of 30% by weight the yield based on catalyst mass decreases; the high proportion of active component appears to fill the small pores, thus reducing the available surface area.

At a comparable loading of 7% by weight the best CeO₂/ZrO₂ microparticle catalyst (2.25 kg_{Cl2}/kg_{CAT}·h, ex. 1) exhibits a yield based on the catalyst mass that is 1.9 times higher than the best noninventive alternative catalyst (CeO₂/ZrO₂: 1.17 kg_{Cl2}/kg_{CAT}·h, ex. 13). The active component cerium is thus markedly better utilized in the case of these novel CeO₂/ZrO₂ microparticle catalysts than in the case of other commonly used supports.

The best CeO₂/ZrO₂ microparticle catalyst (2.72 kg_{Cl2}/kg_{CAT}·h, ex. 4) exhibits a yield based on the catalyst mass that is 2.1 times higher than the best noninventive alternative catalyst (CeO₂/ZrO₂: 1.28 kg_{Cl2}/kg_{CAT}·h, ex. 14).

1.-17. (canceled)

18. A catalyst material composed of a porous catalyst support and a catalytic coating for a process for thermocatalytic production of chlorine from hydrogen chloride and oxygen-containing gas, wherein the catalyst material at least comprises: at least one oxide compound of cerium as the catalytic coating and spherical zirconium dioxide microparticles as the support component.

19. The catalyst material as claimed in claim 18, wherein the catalyst has a bulk density of at least 700 kg/m³ measured in a DN100 graduated cylinder having a fill height of 250 mm.

20. The catalyst material as claimed in claim 18, wherein the catalyst support consists of zirconium dioxide to an extent of at least 90% by weight.

21. The catalyst material as claimed in claim 18, wherein the catalyst support consists of spherical particles, wherein the principal dimension of the particles is on average from 0.1 mm to not more than 1.0 mm.

22. The catalyst material as claimed in claim 21, wherein the average particle size of the catalyst support is from 0.1 mm to not more than 1.0 mm, and the D₉₀ and D₁₀ values of the particle size distribution deviate from the D₅₀ value by not more than 10%, in particular measured by laser diffraction.

23. The catalyst material as claimed in claim 18, wherein the catalyst material is subjected to a high temperature calcination in the presence of oxygen-containing gases, wherein the calcination temperature is in the range 300° C. to 1100° C.

24. The catalyst material as claimed in claim 23, wherein the high-temperature calcination is effected over a period of 30 min to 24 h.

25. The catalyst material as claimed in claim 18, wherein the porous catalyst support in the uncoated state has a bimodal pore diameter distribution, wherein the median diameter of a pore class 1 of relatively large pores is from 30 to 200 nm and the median diameter of a pore class 2 of relatively small pores is from 2 to 25 nm, wherein the pore diameters are in particular measured by mercury porosimetry.

26. The catalyst material as claimed in claim 18, wherein the catalyst support in the uncoated state has a surface area of 30 to 250 m²/g, measured by the method of nitrogen adsorption with evaluation according to BET.

27. The catalyst material as claimed in claim 18, wherein the zirconium dioxide support component is present in the monoclinic crystal form to an extent of at least 90% by weight.

28. The catalyst material as claimed in claim 18, wherein the content of cerium in the catalyst material is 1% to 30% by weight.

29. The catalyst material as claimed in claim 18, wherein the oxide compound of cerium is selected from Ce(III) oxide (Ce₂O₃) and cerium(IV) oxide (CeO₂).

30. The catalyst material as claimed in claim 18, wherein the catalyst material is obtained by applying a cerium compound to the support by means of dry impregnation and the impregnated support is subsequently dried and calcinated at relatively high temperature.

31. The use of the catalyst material as claimed in claim 18 as a catalyst in the thermocatalytic production of chlorine from hydrogen chloride and an oxygen-containing gas.

32. A process for thermocatalytic production of chlorine from hydrogen chloride and oxygen-containing gas, wherein a catalyst material as claimed in claim 18 is used as catalyst.

33. The process as claimed in claim 32, wherein the cerium-containing catalyst material is combined with a ruthenium catalyst or a catalyst containing ruthenium compounds on a separate support, wherein the ruthenium catalyst is employed as a low-temperature complement, and the cerium-containing catalyst material is employed as a high-temperature complement.

34. The process as claimed in claim 33, wherein the two different catalyst types are arranged in different reaction zones.
